(19) United States
(12) Patent Application Publication
(10) Pub. No.: US 2014/0365108 A1
(43) Pub. Date: Dec. 11, 2014

(54) PARKING CONTROL METHOD, DEVICE AND SYSTEM

(71) Applicant: MANDO CORPORATION, Pyeongtaek-si (KR)

(72) Inventor: Kwan Sun YOU, Yongin-si (KR)

(73) Assignee: MANDO CORPORATION

(21) Appl. No.: 14/301,710

(22) Filed: Jun. 11, 2014

(30) Foreign Application Priority Data
Jun. 11, 2013 (KR) 10-2013-0066448

(51) Int. Cl. B62D 15/02

(52) U.S. Cl. CPC B62D 15/027
USPC 701/408

(57) ABSTRACT

The present invention relates to a parking control technology of a vehicle. The present invention provides a parking control method including: searching a parking space by sensing a left or right object existing on a left or right side of a parking space while moving along a parking passage; and acquiring sensing information for an opposite side object existing opposite to the searched parking space with reference to the parking passage, and calculating a parking route for parking a vehicle in the parking space based on the acquired sensing information. The parking control method enables a parking control to a target parking space even if the parking passage width is narrow.

### CROSS-REFERENCE TO RELATED APPLICATION

This application claims priority from and the benefit under 35 U.S.C. §119(a) of Korean Patent Application No. 10-2013-0066448, filed on Jun. 11, 2013, which is hereby incorporated by reference for all purposes as if fully set forth herein.

### BACKGROUND OF THE INVENTION

1. Field of the Invention

The present invention relates to a parking control technology for a vehicle.

2. Description of the Prior Art

As vehicles increase, spaces for parking vehicles are reduced in a limited area or town. In order to solve a problem of lack of parking spaces, a parking section divided to allow one vehicle to be parked therein becomes narrower and narrower.

In addition, even in a space where parking sections are not divided, it is unavoidable that an inter-vehicle space is narrowed when a number of vehicles are parked together therein. It is difficult for a driver to directly drive and park a vehicle in a narrow parking space while looking for an obstacle around the vehicle with his/her eyes within the vehicle. In particular, when an unskilled driver moves a vehicle for parking, it is highly probable that the vehicle collides with a vehicle or an obstacle therearound, which may lead to an accident.

### SUMMARY OF THE INVENTION

In this background, an aspect of the present invention is to provide a parking control method, a parking control device, and a parking control system which enable a stable parking control of a vehicle without causing the vehicle to collide with an obstacle therearound when parking the vehicle in a target parking space.

Another aspect of the present invention is to provide a parking control method, a parking control device, and a parking control system which enable a parking control to a target parking space even in a case where a width of a parking passage is narrow.

In accordance with an aspect of the present invention, there is provided a parking control method including: searching a parking space by sensing a left or right object existing on a left or right side of a parking space while moving along a parking passage; and acquiring sensing information for an opposite side object existing opposite to the searched parking space with reference to the parking passage, and calculating a parking route for parking a vehicle in the parking space based on the acquired sensing information.

According to another aspect of the present invention, there is provided a parking control device including: a parking space search unit configured to search a parking space by sensing a left or right object existing on a left or right side of a parking space while moving along a parking passage; and a parking route calculation unit configured to acquire sensing information for an opposite side object existing opposite to the searched parking space with reference to the parking passage, and to calculate a parking route for parking a vehicle in the parking space based on the acquired sensing information.

According to still another aspect of the present invention, there is provided a parking control system including: a sensor unit configured to sense an object around a vehicle and generate sensing information while the vehicle moves along a parking passage; and a parking control device configured to search a parking space based on the sensing information related to a left or right object existing on the left or right side of the parking space in the information transmitted from the sensor unit and calculate a parking route for parking the vehicle in the parking space based on the sensing information for an opposite side object existing opposite to the searched parking space.

As described above, according to the present invention, it is possible to perform a stable parking control of a vehicle without causing the vehicle to collide with an obstacle positioned opposite to the parking space when parking the vehicle in a target parking space.

In addition, since it is possible to perform a parking control to a target parking space even in a case where a width of a parking passage is narrow, a user's convenience as well as the user's confidence in the parking control system can be enhanced.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a configuration of a parking control system according to an exemplary embodiment of the present invention;

FIG. 2 is a block diagram illustrating a configuration of a parking control device according to an exemplary embodiment of the present invention;

FIG. 3 is a view briefly exemplifying a parking control method according to an exemplary embodiment of the present invention;

FIG. 4 is a view exemplifying a first route in a parking control device according to an exemplary embodiment of the present invention;

FIG. 5 is a view illustrating a method of setting corner points of a vehicle in a parking control device according to an exemplary embodiment of the present invention;

FIG. 6 is a flowchart illustrating a parking control method according to an exemplary embodiment of the present invention; and

FIG. 7 is a flow chart illustrating a parking control method according to another exemplary embodiment of the present invention.

### DETAILED DESCRIPTION OF THE EXEMPLARY EMBODIMENTS

Hereinafter, exemplary embodiments of the present invention will be described with reference to the accompanying drawings. In the following description, the same elements will be designated by the same reference numerals even if they are shown in different drawings. Further, in the following description of the present invention, a detailed description of known functions and configurations incorporated herein will be omitted when it may make the subject matter of the present invention rather unclear.

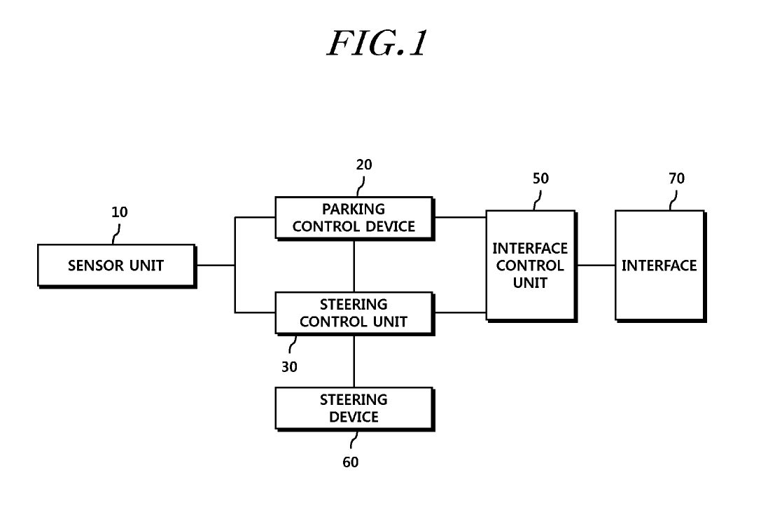

FIG. 1 is a block diagram illustrating a configuration of a parking control system according to an exemplary embodiment of the present invention.

Referring to FIG. 1, a parking control system according to an exemplary embodiment of the present invention includes: a sensor unit 10 including one or more sensors configured to sense an object around a vehicle and generate sensing information while the vehicle moves along a parking passage; and a parking control device 20 configured to search a parking space based on the sensing information transmitted from the sensor unit 10 and to calculate a parking route so as to perform a parking control.

In addition, the parking control system may include a steering control unit 30 connected with the parking control device 20 to control an operation of a steering device 60 such that the vehicle may move along the parking route calculated by the parking control device 20, and an interface control unit 50 configured to perform a control such that the parking route calculated by the parking control device 20 or a parking control message according to the parking route may be indicated to a driver through an interface 70.

The parking control device 20 according to the exemplary embodiment of the present invention may calculate the parking route for parking the vehicle in the searched parking space on the basis of sensing information for an object on the opposite side of the searched parking space in the sensing information transmitted from the sensor unit 10. At this time, the parking control device 20 may be connected with the sensor unit 10, the steering control unit 30, and the interface control unit 50 so as to calculate a parking route and to generate and transmit a control signal to each component of the vehicle such that the parking control can be performed according to the calculated parking route.

In the present invention, the object may correspond to another parked vehicle, a structure of a building, an installation, or the like. However, in the present specification, a description will be made assuming that the object is a parked vehicle, as needed.

In addition, the parking control system according to the exemplary embodiment of the present invention may be applied to various types of parking such as perpendicular parking, parallel parking, front parking, and rear parking. However, the parking control system may further enhance a driver's stability when it is applied to the perpendicular parking in which the vehicle is likely to collide with an obstacle existing opposite to the parking space while turning to move in a process of parking. Accordingly, when necessary, descriptions will be made herein with reference to a case where an exemplary embodiment of the present invention is applied to the perpendicular parking type as an example.

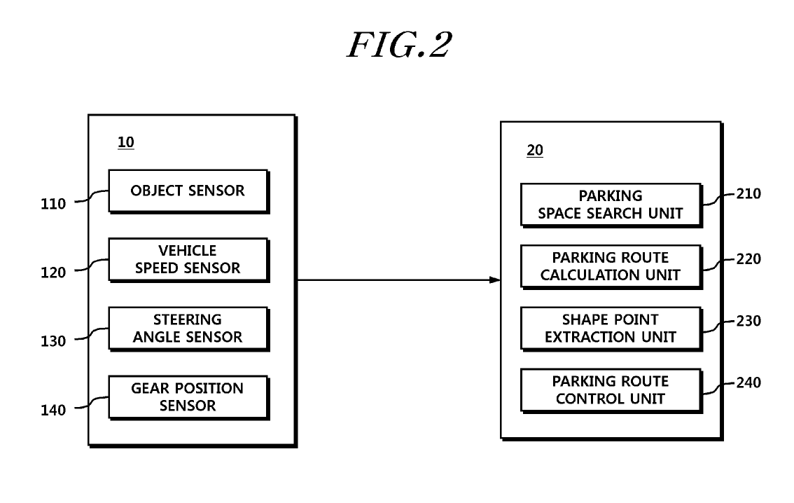

FIG. 2 is a block diagram illustrating a configuration of a parking control device according to an exemplary embodiment of the present invention.

Referring to FIG. 2, a parking control device 20 according to an exemplary embodiment may include: a parking space search unit 210 configured to search a parking space while moving along a parking passage; and a parking route calculation unit 220 configured to acquire sensing information for an opposite side object which is existing opposite to the searched parking space with reference to the parking passage and to calculate a parking route based on the acquired sensing information.

The parking control device 20 may include: a shape point extraction unit 230 configured to extract a shape point of the opposite side object based on the sensing information; and a parking route control unit 240 configured to control the operation of the vehicle such that the vehicle moves along the parking route calculated by the parking route calculation unit 220.

The parking control device 20 may acquire the sensing information from the sensor unit 10. The sensor unit 10 includes one or more object sensors 110, a vehicle speed sensor 120, a steering angle sensor 130, and a gear position sensor 140 so that an output signal from each of the sensors can be transmitted to the parking control device 20 as the sensing information.

The object sensors 110 may be respectively mounted on front, rear, left and right surfaces of the vehicle to sense an object around the vehicle, and may transmit a signal according to the sensing to the parking control device 20 as the sensing information for the object. An ultrasonic sensor may be, but not exclusively, applied as each object sensor 110.

The parking route calculation unit 220 may set corner points at front, rear, left and right sides with respect to the vehicle and generate corner point information for each of the set corner points. The parking route calculation unit 220 may calculate a turning route such that any one of the corner point information for at least one corner point and the shape point information acquired from the shape point extraction unit 230 can maintain a separation distance which is equal to or larger than a reference value.

Hereinafter, the operation of the parking route calculation unit 220 according to an exemplary embodiment of the present invention will be described. For the convenience of description, a vehicle which searches a parking space by the parking control device 20 and moves to the searched parking space according to the exemplary embodiment of the present invention will be referred to as a “vehicle-to-park”, a vehicle existing on a left or right side of the parking space will be referred to as a “left or right obstacle vehicle”, and a vehicle existing opposite to the parking space with reference to the parking passage will be referred to as an “opposite side obstacle vehicle”.

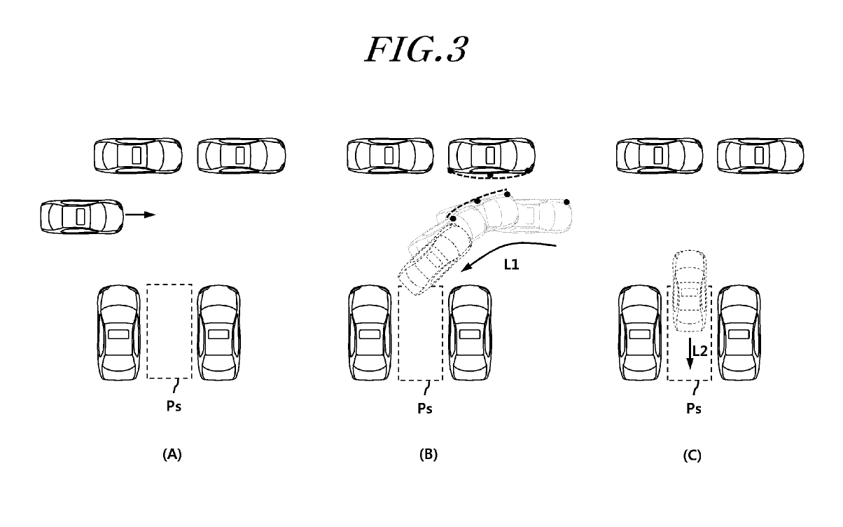

FIGS. 3a to 3c are views illustrating a concept of a parking control method according to an exemplary embodiment of the present invention.

Referring to FIG. 3a, when a parking control is started, the parking control device 20 according to the exemplary embodiment of the present invention acquires sensing information generated by the sensor unit 10 while the vehicle-to-park moves along a parking passage so as to search a parking space.

When the parking space is searched and determined as the parking space Ps for parking the vehicle-to-park, the parking control is performed such that the parking control device 20 calculates a parking route based on a relationship between the position of the parking space Ps determined according to the search and the current position of the vehicle-to-park and causes the vehicle-to-park to move along the calculated parking route.

At this time, as illustrated in FIGS. 3b and 3c, the parking route calculated by the parking route calculation unit 220 may include a first route L1 in which the vehicle-to-park turns to move from the current position to a position adjacent to the parking space Ps and a second route L2 in which the vehicle-to-park moves from the final point of the first route L1 to a parking control termination point inside the parking space Ps in which the first route L1 is calculated such that the vehicle-to-park may turn while sufficiently avoiding an opposite side obstacle vehicle.

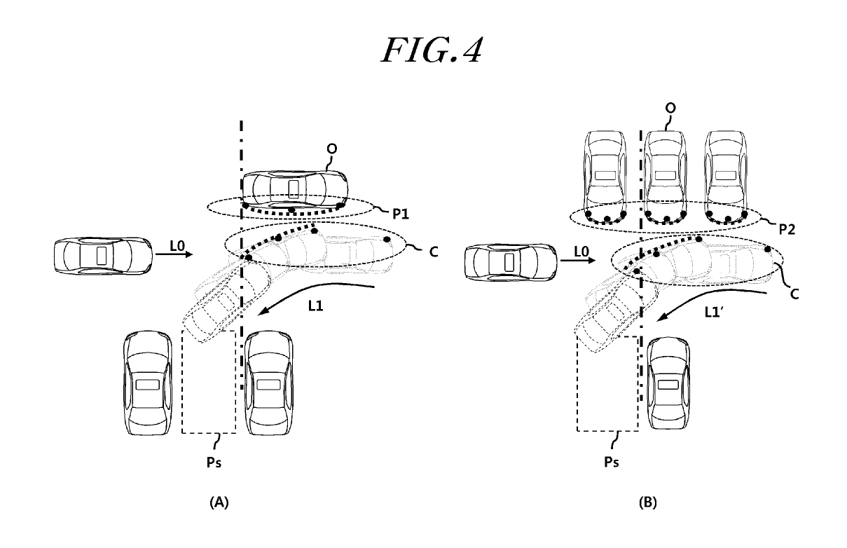

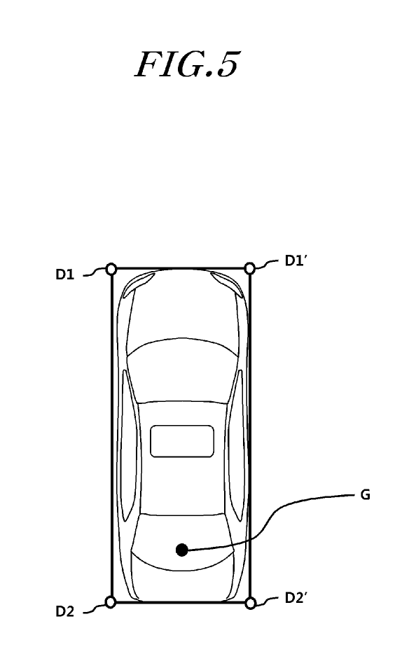

FIG. 4 is a view briefly illustrating an example of calculating a first route by a parking route calculation unit in the parking control device according to the exemplary embodiment of the present invention, and FIG. 5 is a view illustrating a method of setting corner points of a vehicle in a parking control device according to an exemplary embodiment of the present invention.

Referring to FIG. 4, in the parking control device 20 according to the exemplary embodiment of the present invention, the parking route calculation unit 220 may set a corner point adjacent to the opposite side obstacle vehicle O among corner points of the vehicle-to-park as a to-be-avoided corner point C. In addition, the parking route calculation unit 220 receives shape point information for a shape point P1 shape of the opposite side obstacle vehicle O from a shape point extraction unit 230.

At this time, the corner points of the vehicle-to-park may be set with reference to a central point G of the vehicle-to-park as illustrated in FIG. 5. A center of the rear wheel axle of the vehicle-to-park may be set as the central point G in which the parking control in relation to the parking space may be performed with reference to the central point G.

The corner points D1, D1′, D2, and D2′ of the vehicle-to-park may be set as the corner points of a rectangular shape formed by tangential lines of front, rear, left and right surfaces of the vehicle. A positional coordinate of each corner point may be calculated based on the widthwise and longitudinal lengths of the vehicle-to-park and the positional coordinate of the central point. The widthwise length of the vehicle, the length of the axle, a front body overhang, and a rear body overhang are determined when the corresponding vehicle is manufactured and may be stored in advance in a memory of the parking control device 20. Accordingly, the positional coordinates of the rear left and right corner points D2 and D2′ among the corner points may be calculated based on a reference coordinate value set with respect to the central point G and the rear body overhang value and the positional coordinates of the front left and right corner points D1 and D1′ may also be calculated based on the reference coordinate value, the length of the axle, and the front body overhang value.

The shape point extraction unit 230 may extract shape points P1 and P2 of an opposite side obstacle vehicle O based on the sensing information acquired through the sensor unit 10 while the vehicle-to-park moves along the parking passage.

The sensing information may include information related to a distance to an object sensed by an object sensor 110, and the shape point extraction unit 230 may recognize a contour shape of the opposite side obstacle vehicle O based on the sensing information acquired from the object sensor 110 of the vehicle-to-park which is positioned on the opposite side obstacle vehicle O. In addition, the shape point extraction unit 230 may extract a plurality of shape points P1 and P2 from the recognized contour shape. Shape point information including positional coordinates for the extracted shape points is generated based on the reference coordinate, a moving distance, or the like, and the generated shape point information is transferred to the parking route calculation unit 220.

In relation to the recognized contour shape, the shape point extraction unit 230 may extract preferably three shape points which correspond to both side corner points and the central point of the recognized contour shape, respectively. However, the present invention is not limited thereto and the shape points to be extracted may be easily changed by a person ordinarily skilled in the art.

While the shape points P1 and P2 of the opposite side obstacle vehicle respectively have fixed position values, the positional coordinate of the to-be-avoided corner point C is varied as the vehicle-to-park moves. Thus, it is preferable for the parking route calculation unit 220 to calculate the parking route based on the shape point information such that the to-be-avoided corner point C is separated from the shape points P1, P2 by at least a predetermined distance.

The value of the positional coordinate of the to-be-avoided corner point C may vary depending on how a turning angle is set. Accordingly, the parking route calculation unit 220 may calculate the largest turning route by calculating the largest coordinate value at which the shape points P1 and P2 and the to-be-avoided corner point C do not collide with each other, that is, the coordinate value of the to-be-avoided corner point at a point where the distance between the shape points P1 and P2 and the to-be-avoided corner point C is the minimum distance (the fixed distance) for avoiding the collision, and may calculate the first routes L1 or L1′ not to deviated from the maximum turning route.

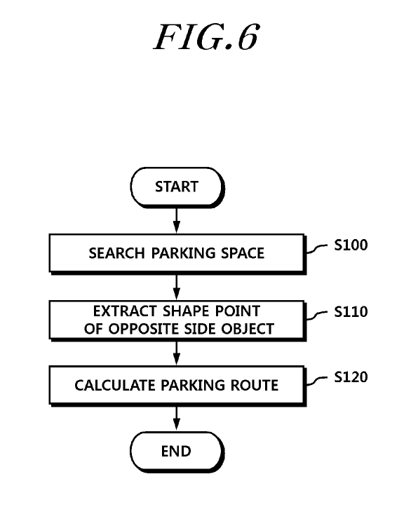

FIG. 6 is a flowchart illustrating a parking control method according to an exemplary embodiment of the present invention.

Referring to FIG. 6, the parking control method according to an exemplary embodiment of the present invention includes: searching a parking space by sensing an object around a vehicle-to-park while the vehicle-to-park moves along a parking passage (S100); and calculating a parking route based on sensing information acquired with respect to the object around the vehicle (S120).

In addition, the parking control method may include extracting a shape point of the opposite side object based on the sensing information acquired from the sensor unit 10 (S110), before calculating the parking route (S120).

In the searching of the parking space (S100), first, when obstacle vehicles existing on both left and right sides with reference to the parking passage are sensed while the vehicle-to-park moves along parking passage, the sensing information is received in response thereto. In addition, at least one of the position, width, and depth of the parking space is calculated based on the sensing information for any of the objects existing on the left and right sides of the parking space in the received sensing information to perform a parking space search operation.

When calculating the parking route (S120), the parking route is calculated based on the sensing information for an opposite side object existing opposite to the parking space in the sensing information, a turning route for avoiding collision with the opposite side object (including an opposite side obstacle vehicle) may be calculated based on the position to the parking pace in relation to the current position of the vehicle-to-park.

After calculating the parking route calculation step (S120), a control signal may be generated and transmitted to each component of the vehicle-to-park such that the vehicle-to-park moves along the calculated parking route. When it is determined that the vehicle-to-park is positioned at a final position of the calculated parking route, it may be determined that the parking control is completed to terminate the parking control.

Meanwhile, the parking control method according to the exemplary embodiment of the present invention as described above may be selectively applied according to the parking passage width.

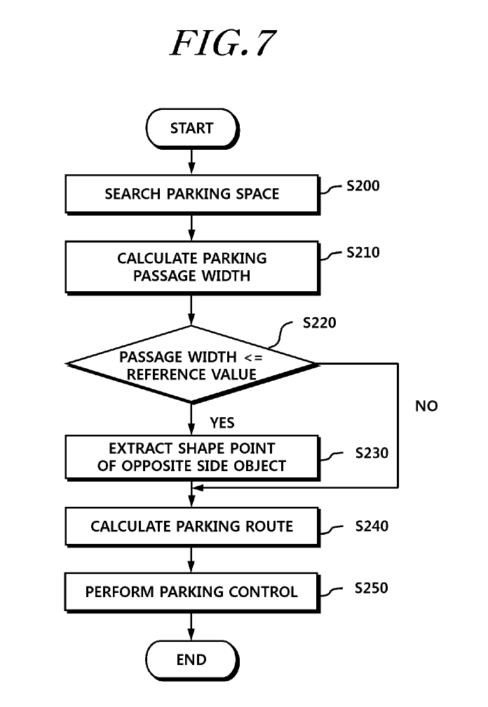

FIG. 7 is a flow chart illustrating a parking control method according to another exemplary embodiment of the present invention.

Referring to FIG. 7, in the parking control method according to another exemplary embodiment of the present invention, first, sensing information of objects around a vehicle-to-park generated by a sensor unit 10 is acquired while the vehicle-to-park moves along a parking passage, and a parking space is searched based on the acquired sensing information. At this time, the sensor unit 10 may search the parking space by calculating the position, width, depth or the like of the parking space based on sensing information for an object existing on a left or right side of the parking space in the acquired sensing information (S200)

Next, a parking route control unit 240 calculates the parking passage width based on the sensing information. That is, the parking route control unit 240 may calculate a distance between the vehicle-to-park and a left side obstacle vehicle existing on the left side of the to-be-parked surface based on the sensing information acquired from the object sensors 110 mounted on the left and right surfaces of the vehicle-to-park. Similarly, the parking route control unit 240 may calculate a distance between the vehicle-to-park and a right side obstacle vehicle existing on the right side of the vehicle-to-park, in which the passage width value of the parking passage may be calculated from each of the calculated distance values (S210).

The parking route control unit 240 compares the calculated passage width value with a pre-set reference value (S220). As a result of the comparison, when the calculated passage width value is larger than the reference value, the parking route control unit 220 may generate a control signal which enables calculation of a first parking route for the vehicle-to-park and transmit the control signal to a parking route calculation unit 220 (S240).

The first parking route may include: a first reverse travel route where the vehicle-to-park reversely travels to a position adjacent to the parking position from the current position of the vehicle-to-park based on the sensing information for the left and right side obstacle vehicles of the vehicle-to-park; a second forward travel route where the vehicle-to-park forwardly moves from a final point of the first reverse travel route; and a third reverse travel route where the vehicle-to-park reversely travels from the final point of the second forward travel route to enter the parking space, the parking control being terminated when a parking reference point of the vehicle-to-park reaches a final point of the third reverse travel route.

As a result of comparison in the parking route control unit 240, when the calculated passage width value is equal to or smaller than the reference value, the parking route control unit 240 may generate a control signal which causes another parking route to be calculated and transmit the control signal to the parking route calculation unit 220.

At this time, the parking route control unit 240 may generate and transmit the control signal to a shape point extraction unit such that the shape point extraction unit may extract a shape point of the opposite side obstacle vehicle existing opposite to the parking space. Then, the shape point extraction unit may transmit shape point information for the shape point extracted for the opposite side obstacle vehicle to the parking route calculation unit 220 (S230).

The parking route calculation unit 220 may calculate the parking route based on the shape point information transmitted from the shape point extraction unit and the current position information of the vehicle-to-park, and a parking control is performed such that the vehicle-to-park may move along the calculated parking route (S240, S250).

That is, in the case of the perpendicular reverse parking method, a route where the vehicle-to-park forwardly travels toward an opposite side object from the parking passage may be generated in order to guide the vehicle-to-park to the inside of the parking space. As a result, the parking passage should have a width which allows the calculation of the forward travel route so as to enable the parking control using the forward travel route.

Accordingly, in the prior art, even if the parking control is initiated, when it is determined that the parking passage width is equal to or smaller than the reference value, a message notifying that the parking control is impossible is indicated and the parking control is merely stopped.

However, according to another exemplary embodiment of the present invention, when the parking passage width along the parking passage is equal to or smaller than the reference value, the parking control method calculates a turning route for entering the parking space while avoiding the opposite side obstacle vehicle is calculated so as to enable the parking control, and when the parking passage width is larger than the reference value, the parking control method calculates the parking route including a route for forward travel from the parking passage as described above so as to enable the parking control. Consequently, the user's safety and convenience related to a parking control may be further enhanced.

Although the exemplary embodiments of the present invention have been described for illustrative purposes, those skilled in the art will appreciate that various modifications and substitutions are possible, without departing from the scope and spirit of the invention as disclosed in the accompanying claims. Therefore, the exemplary embodiments disclosed in the present invention are intended to illustrate the scope of the technical idea of the present invention, and the scope of the present invention is not limited by the exemplary embodiments.

What is claimed is:

1. A parking control method comprising:
searching a parking space by sensing a left or right object existing on a left or right side of a parking space while moving along a parking passage; and
acquiring sensing information for an opposite side object existing opposite to the searched parking space with reference to the parking passage, and calculating a parking route for parking a vehicle in the parking space based on the acquired sensing information.

2. The parking control method of claim 1, further comprising:
extracting a shape point of the opposite side object based on the sensing information before the calculating of the parking route.

3. The parking control method of claim 1, wherein the searching of the parking space includes calculating a parking passage width while moving along the parking passage.

4. The parking control method of claim 3, wherein in the calculating of the parking route, when the calculated passage width information is larger than a pre-set reference value, the parking route is calculated based on sensing information for the left or right object, and when the passage width information is equal to or smaller than the reference value, the parking route is calculated based on the sensing information for the opposite side object.

5. A parking control device comprising:
a parking space search unit configured to search a parking space by sensing a left or right object existing on a left or right side of a parking space while moving along a parking passage; and
a parking route calculation unit configured to acquire sensing information for an opposite side object existing opposite to the searched parking space with reference to the parking passage, and to calculate a parking route for parking a vehicle in the parking space based on the acquired sensing information.

6. The parking control device of claim 5, further comprising:
a shape point extraction unit configured to extract one or more shape points of the opposite side object based on the sensing information.

7. The parking control device of claim 6, wherein the parking route calculation unit sets each of corner points for the vehicle and calculates a turning route such that any one of the set corner points and any one of the shape points of the opposite side object which are extracted by the shape point extraction unit are maintained at a separation distance which is equal to or larger than a reference value.

8. A parking control system comprising:
a sensor unit configured to sense an object around a vehicle and generate sensing information while the vehicle moves along a parking passage; and
a parking control device configured to search a parking space based on sensing information for a left or right object existing on the left or right side of the parking space in the sensing information transmitted from the sensor unit and calculate a parking route for parking the vehicle in the parking space based on the sensing information for an opposite side object existing opposite to the searched parking space.
